(19) United States
(12) Patent Application Publication
(10) Pub. No.: US 2006/0289210 A1
(43) Pub. Date: Dec. 28, 2006

(54) Hybrid vehicle and control method of the same

(75) Inventor: Masashi Yoshimi, Toyota-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/472,422

(22) Filed: Jun. 22, 2006

(30) Foreign Application Priority Data
Jun. 23, 2005 (JP) 2005-183085

(51) Int. Cl. B60K 6/00

(52) U.S. Cl. 180/65.2

(57) ABSTRACT

In the gate shutdown state of all switching elements included in an inverter for a motor MG1 (step S114) or in the gate shut downstate of all switching elements included in an inverter for a motor MG2 (step S122), the braking control of the invention uses disk brakes to output a supplementary braking force and compensate for an insufficiency of braking force. This arrangement effectively prevents an unintentional decrease of braking force applied to a hybrid vehicle even in the event of insufficiency in engine resistant braking force output from the motor MG1 to a driveshaft or in regenerative braking force output from the motor MG2 to the driveshaft.

### BACKGROUND OF THE INVENTION

1. Field of the Invention

The present invention relates to a hybrid vehicle and a control method of the same. More specifically the invention pertains to a hybrid vehicle that outputs power to a driveshaft, as well as to a control method of such a hybrid vehicle.

2. Description of the Related Art

Among automobiles outputting power to a driveshaft, conventional engine vehicles have an engine braking system, while electric vehicles have a motor regenerative braking system. In response to a detected decrease or an expected decrease in engine braking force or motor regenerative braking force in a vehicle-braking state, one proposed technique applies wheel brakes irrespective of the driver's braking operation to compensate for a decrease in the engine braking force or the motor regenerative braking force (see, for example, Japanese Patent Laid-Open Gazette No. H10-203203). In the event of a decrease in engine braking effect or motor regenerative braking effect, the driver conventionally depresses a brake pedal and actuates the wheel brakes to apply a supplementary braking force and compensate for the decreased braking force. In the event of a decrease in engine braking force or motor regenerative braking force, this proposed technique, on the other hand, automatically actuates the wheel brakes irrespective of the driver's depression of the brake pedal to compensate for the decreased braking force. Namely this prior art technique prevents an unintentional decrease in braking force applied to the vehicle even in the event of a decrease in engine braking force or motor regenerative braking force and does not require the driver's any additional operation, for example, depression of the brake pedal, to compensate for the decreased braking force.

This prior art technique is, however, only applicable to the conventional engine vehicle or to the electric vehicle to handle a decrease in braking force output from only one power-generating machine, that is, either the engine or the motor. This technique is not applicable to a hybrid vehicle that is driven with control of input and output of both an engine power and a motor power to the driveshaft and can not handle a decrease in braking force output from at least one of the two power-generating machines, that is, both the engine and the motor.

### SUMMARY OF THE INVENTION

The object of the invention is thus to eliminate the drawbacks of the prior art technique and to provide a hybrid vehicle and a corresponding hybrid vehicle control method that prevent an unintentional decrease in braking force applied to the vehicle even in the event of an insufficiency of a resistant braking force generated by a rotational resistance of an internal combustion engine or in the event of an insufficiency of a regenerative braking force output to a driveshaft by means of a motor.

In order to attain at least part of the above and the other related objects, the present invention is constructed as follows.

The present invention is directed to a hybrid vehicle that outputs power to a driveshaft. The hybrid vehicle of the invention includes: an internal combustion engine that has an output shaft and outputs power; an electric power-mechanical power input output mechanism that is connected with the output shaft of the internal combustion engine and with the driveshaft and outputs at least part of the power of the internal combustion engine to the driveshaft with input and output of electric power while outputting a resistant braking force by a rotational resistance arising in the internal combustion engine to the driveshaft with input of electric power; a motor that converts power of the driveshaft to electric power to output a regenerative braking force to the driveshaft; and a braking force output unit that outputs a braking force to the driveshaft. The hybrid vehicle of the invention also has a braking control module that sets a resistant braking force demand to be output from the electric power-mechanical power input output mechanism to the driveshaft and a regenerative braking force demand to be output from the motor to the driveshaft and controls the electric power-mechanical power input output mechanism and the motor to ensure output of the resistant braking force demand and the regenerative braking force demand to the driveshaft. When the electric power-mechanical power input output mechanism totally fails to output the resistant braking force demand or outputs only part of the resistant braking force demand or when the motor totally fails to output the regenerative braking force demand or outputs only part of the regenerative braking force demand, the braking control module executes braking force supplement control, which controls the electric power-mechanical power input output mechanism, the motor, and the braking force output unit to ensure supplementary output of an insufficient braking force from at least one of the electric power-mechanical power input output mechanism, the motor, and the braking force output unit.

In the hybrid vehicle of the invention, when the electric power-mechanical power input output mechanism or the motor outputs a smaller braking force than the braking force demand or does not output any braking force at all, at least one of the electric power-mechanical power input output mechanism, the motor, and the braking force output unit is used to output a supplementary braking force and compensate for an insufficiency of braking force. This arrangement effectively prevents an unintentional decrease in braking force applied to the vehicle even in the event of an insufficiency of a resistant braking force of the internal combustion engine output to the driveshaft by the electric power-mechanical power input output mechanism or in the event of an insufficiency of a regenerative braking force output to the driveshaft by means of the motor.

In one preferable embodiment of the invention, the hybrid vehicle further includes an accumulator unit that inputs and outputs electric power from and to the electric power-mechanical power input output mechanism and the motor. The braking control module sets the regenerative braking force demand to restrict the input and output of the electric power to and from the accumulator unit within a preset restriction range. In one structure of this preferable embodiment, the hybrid vehicle further has: a first driving circuit that is arranged between the electric power-mechanical power input output mechanism and the accumulator unit and has multiple switching elements, which are switched on and off to drive the electric power-mechanical power input output mechanism; and a second driving circuit that is arranged between the motor and the accumulator unit and has multiple switching elements, which are switched on and off to drive the motor. The braking control module executes the braking force supplement control when the multiple switching elements in the first driving circuit are all switched off or when the multiple switching elements in the second driving circuit are all switched off.

In the gate shutdown state of the driving circuit for driving the electric power-mechanical power input output mechanism or the driving circuit for driving the motor, all the switching elements included in the driving circuit are switched off. The electric power-mechanical power input output mechanism or the motor connecting with the driving circuit in the gate shutdown state can not output a required braking force and thus undesirably decreases the braking force applied to the vehicle. The technique of the invention is especially effective in such a state having a potential for a decrease in braking force applied to the vehicle, for example, in the gate shutdown state of the driving circuit for driving the electric power-mechanical power input output mechanism or the driving circuit for driving the motor. In one application of the hybrid vehicle of this structure, the accumulator unit is charged with electric power converted from the power of the driveshaft, while the motor outputs a braking force to the driveshaft. When the electric power-mechanical power input output mechanism totally fails to output the resistant braking force demand or outputs only part of the resistant braking force demand, the braking control module specifies a distribution ratio of an insufficient braking force to the motor and the braking force output unit based on a state of charge of the accumulator unit and controls the motor and the braking force output unit to output supplementary braking forces according to the specified distribution ratio and compensate for the insufficient braking force. While the electric power-mechanical power input output mechanism totally fails to output the resistant braking force demand or outputs only part of the resistant braking force demand, the motor may be capable of regenerating the power of the driveshaft in the form of electric power. In this state, the regenerative braking force of the motor compensates for at least part of the insufficient braking force and thereby enhances the total energy efficiency of the hybrid vehicle.

In one preferable application of the hybrid vehicle of the invention, when the electric power-mechanical power input output mechanism totally fails to output the resistant braking force demand or outputs only part of the resistant braking force demand or when the motor totally fails to output the regenerative braking force demand or outputs only part of the regenerative braking force demand, the braking control module controls the braking force output unit to output a supplementary braking force and compensate for an insufficiency of braking force. The braking forceoutputunit outputs the supplementary braking force irrespective of the operating conditions of the electric power-mechanical power input output mechanism and the motor and well compensates for all the insufficiency of braking force.

In another preferable application of the hybrid vehicle of the invention, the braking force output unit has a brake that outputs a hydraulic pressure-based braking force to the driveshaft by actuation of an actuator. At least part of the hydraulic brake structure conventionally mounted on the automobile is applicable to the braking force output unit. There is accordingly no need of providing any additional complicated braking system for outputting the braking force. The actuator may be a solenoid valve or a pump.

In another preferable embodiment of the invention, the hybrid vehicle further includes a gear speed change unit that has multiple different gear speeds selectable by a driver and gives a quasi-upshift effect or a quasi-downshift effect based on selection of a gear speed. The braking control module sets the resistant braking force demand and the regenerative braking force demand to increase output of a braking force to the driveshaft in response to the driver's selection of a lower gear speed among the multiple different gear speeds of the gear speed change unit. The braking control module executes the braking force supplement control when the electric power-mechanical power input output mechanism totally fails to output the resistant braking force demand or outputs only part of the resistant braking force demand or when the motor totally fails to output the regenerative braking force demand or outputs only part of the regenerative braking force demand, and when the driver's selection of a gear speed is not higher than a preset low gear speed among the multiple different gear speeds of the gear speed change unit. At the lower gear speed, output of a greater braking force is expected from the electric power-mechanical power input output mechanism or from the motor. Under the condition of output of only an insufficient braking force or practically no braking force from the electric power-mechanical power input output mechanism or the motor, the driver feels a severer idle drive at the lower gear speed than at the higher gear speed. The technique of the invention is thus especially effective at the setting of the lower gear speed. The preset lower gear speed is selectable arbitrarily but may be, for example, a second lowest gear speed among five different gear speeds.

In still another preferable application of the hybrid vehicle of the invention, the braking control module executes the braking force supplement control when the electric power-mechanical power input output mechanism totally fails to output the resistant braking force demand or outputs only part of the resistant braking force demand or when the motor totally fails to output the regenerative braking force demand or outputs only part of the regenerative braking force demand, and when a driver's depression amount of an accelerator pedal is decreased or is set practically equal to zero. Under the condition of the decreased depression amount of the accelerator pedal or under the condition of the practically zero depression of the accelerator pedal, the braking force output from the electric power-mechanical power input output mechanism or output from the motor is frequently used to brake the hybrid vehicle. The technique of the invention is especially effective in such situations.

In the hybrid vehicle of the invention, the electric power-mechanical power input output mechanism may include: a three shaft-type power input output module that is linked to three shafts, that is, an output shaft of the internal combustion engine, the drive shaft, and a third shaft, and determines power input from and output to a residual one shaft based on powers input from and output to any two shafts among the three shafts; and a generator that inputs and outputs power from and to the third shaft.

In the hybrid vehicle of the invention, the electric power-mechanical power input output mechanism may include a pair-rotor motor that has a first rotor linked to an output shaft of the internal combustion engine and a second rotor linked to the drive shaft, said pair-rotor motor outputting at least part of the power from said internal combustion engine to said drive shaft through input and output of electric power by electromagnetic interaction between the first rotor and the second rotor.

The present invention is also directed to a control method of a hybrid vehicle that includes: an internal combustion engine that has an output shaft and outputs power; an electric power-mechanical power input output mechanism that is connected with the output shaft of the internal combustion engine and with a driveshaft and outputs at least part of the power of the internal combustion engine to the driveshaft with input and output of electric power while outputting a resistant braking force by a rotational resistance arising in the internal combustion engine to the driveshaft with input of electric power; a motor that converts power of the driveshaft to electric power to output a regenerative braking force to the driveshaft; and a braking force output unit that outputs a braking force to the driveshaft. The control method of the invention includes the steps of setting a resistant braking force demand to be output from the electric power-mechanical power input output mechanism to the driveshaft and a regenerative braking force demand to be output from the motor to the driveshaft and controlling the electric power-mechanical power input output mechanism and the motor to ensure output of the resistant braking force demand and the regenerative braking force demand to the driveshaft, and when the electric power-mechanical power input output mechanism totally fails to output the resistant braking force demand or outputs only part of the resistant braking force demand or when the motor totally fails to output the regenerative braking force demand or outputs only part of the regenerative braking force demand, executing braking force supplement control, which controls the electric power-mechanical power input output mechanism, the motor, and the braking force output unit to ensure supplementary output of an insufficient braking force from at least one of the electric power-mechanical power input output mechanism, the motor, and the braking force output unit.

In this control method of the invention, when the electric power-mechanical power input output mechanism or the motor outputs a smaller braking force than the braking force demand or does not output any braking force at all, at least one of the electric power-mechanical power input output mechanism, the motor, and the braking force output unit is used to output a supplementary braking force and compensate for an insufficiency of braking force. This arrangement effectively prevents an unintentional decrease in braking force applied to the vehicle even in the event of an insufficiency of a resistant braking force of the internal combustion engine output to the driveshaft by the electric power-mechanical power input output mechanism or in the event of an insufficiency of a regenerative braking force output to the driveshaft by means of the motor. The control method of the invention may further include the additional steps to attain functions of the respective modules provided for the hybrid vehicle of the invention described above.

### BRIEF DESCRIPTION OF THE DRAWINGS

FIG. 1 schematically illustrates the configuration of a hybrid vehicle 20 in one embodiment of the invention;

FIG. 2 is a flowchart showing an accelerator-off-time braking control routine in the S position;

FIG. 3 shows variations of input limit Win and output limit Wout against the battery temperature Tb;

FIG. 4 shows variations of input limit correction factor and output limit correction factor against the state of charge SOC of a battery 50;

FIG. 5 shows an example of a torque demand setting map;

FIG. 6 is an alignment chart showing torque-rotation speed dynamics of respective rotation elements included in a power distribution integration mechanism 30;

FIG. 7 is a flowchart showing an accelerator-off-time braking control routine in the S position in one modified structure;

FIG. 8 is a flowchart showing an accelerator-off-time braking control routine in the S position in another modified structure;

FIG. 9 schematically illustrates the configuration of a hybrid vehicle 120A in another embodiment:

FIG. 10 schematically illustrates the configuration of a hybrid vehicle 120B in another embodiment; and

FIG. 11 schematically illustrates the configuration of a hybrid vehicle 120B in another embodiment.

### DESCRIPTION OF THE PREFERRED EMBODIMENTS

One mode of carrying out the invention is described below as a preferred embodiment with reference to the accompanied drawings.

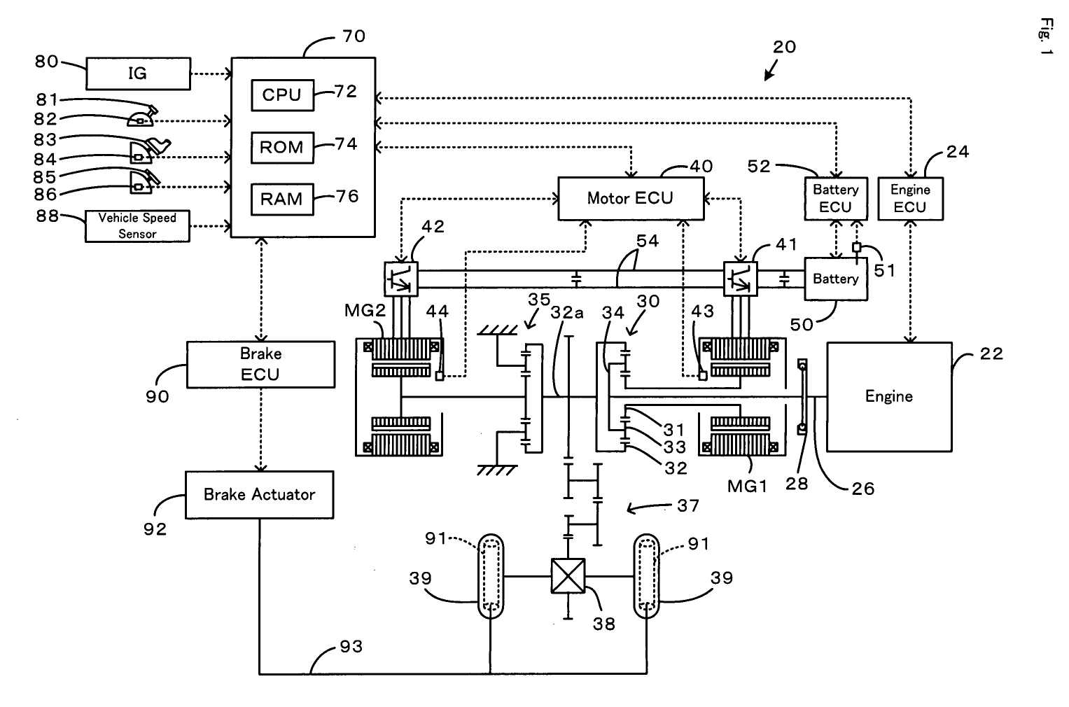

FIG. 1 schematically illustrates the configuration of a hybrid vehicle 20 in one embodiment of the invention. As illustrated, the hybrid vehicle 20 of the embodiment includes an engine 22, a three-shaft-type power distribution integration mechanism 30 that is connected via a damper 28 to a crankshaft 26 or an output shaft of the engine 22, a motor MG1 that is connected to the power distribution integration mechanism 30 and has power generation capability, a motor MG2 that is connected to the power distribution integration mechanism 30 via a reduction gear 35, and a hybrid electronic control unit 70 that controls the whole drive system of the hybrid vehicle 20.

The engine 22 is an internal combustion engine that consumes a hydrocarbon fuel, such as gasoline or light oil, to output power and under operation control of an engine electronic control unit 24 (hereafter referred to as engine ECU 24). The engine ECU 24 inputs diverse signals from various sensors that detect and measure the operating conditions of the engine 22 and performs fuel injection control, ignition control, intake air flow regulation, and other required operation controls and regulations of the engine 22. The engine ECU 24 establishes communication with the hybrid electronic control unit 70 to control the operations of the engine 22 in response to control signals received from the hybrid electronic control unit 70 and to output data regarding the operating conditions of the engine 22 to the hybrid electronic control unit 70 according to the requirements.

The power distribution integration mechanism 30 includes a sun gear 31 as an external gear, a ring gear 32 as an internal gear arranged concentrically with the sun gear 31, multiple pinion gears 33 engaging with the sun gear 31 and with the ring gear 32, and a carrier 34 holding the multiple pinion gears 33 to allow both their revolutions and their rotations on their axes. The power distribution integration mechanism 30 is thus constructed as a planetary gear mechanism including the sun gear 31, the ring gear 32, and the carrier 34 as rotational elements of differential motions. The carrier 34, the sun gear 31, and the ring gear 32 of the power distribution integration mechanism 30 are respectively linked to the crankshaft 26 of the engine 22, to the motor MG1, and to the reduction gear 35 via a ring gear shaft 32a. When the motor MG1 functions as a generator, the power of the engine 22 input via the carrier 34 is distributed into the sun gear 31 and the ring gear 32 corresponding to their gear ratio. When the motor MG1 functions as a motor, on the other hand, the power of the engine 22 input via the carrier 34 is integrated with the power of the motor MG1 input via the sun gear 31 and is output to the ring gear 32. The ring gear 32 is mechanically connected to front drive wheels 39,39 via a gear mechanism 37 and a differential gear 38. The power output to the ring gear 32 is accordingly transmitted to the drive wheels 39,39 via the gear mechanism 37 and the differential gear 38. The three shafts linked to the power distribution integration mechanism 30 in the drive system are the crankshaft 26 that is linked to the carrier 34 and works as the output shaft of the engine 22, a sun gear shaft 31a that is linked to the sun gear 31 and works as a rotating shaft of the motor MG1, and the ring gear shaft 32a that works as the driveshaft and is linked to the ring gear 32 and mechanically connected to the drive wheels 39,39. Disk brakes 91,91 are located inside the drive wheels 39,39.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The motor MG1 also functions as a starter to rotate the crank shaft 26 of the engine 22 at the time of starting the engine. Operations of both the motors MG1 and MG2 are controlled by a motor electronic control unit (hereinafter, referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by non-illustrated current sensors. The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements.

The battery 50 is a secondary battery having charge-discharge capability, and is under control of a battery electronic control unit (hereinafter, referred to as a battery ECU) 52. The battery ECU 52 receives diverse signals required for control of the battery 50, for example, an inter-terminal voltage Vb measured by a non-illustrated voltage sensor disposed between terminals of the battery 50, a charge-discharge current Ib measured by a non-illustrated current sensor attached to the power line 54 connected with the output terminal of the battery 50, and a battery temperature Tb measured by a temperature sensor 57 attached to the battery 50. The battery ECU 52 outputs data relating to the state of the battery 50 to the hybrid electronic control unit 70 according to the requirements. The battery ECU 52 calculates a state of charge (SOC) of the battery 50, based on the accumulated charge-discharge current measured by the current sensor, for control of the battery 50.

The disk brakes 91,91 provided inside the drive wheels 39,39 are connected to a brake actuator 92 included in a hydraulic circuit 93. The brake actuator 92 is constructed, for example, by a solenoid valve or a pump and is controlled by a brake electronic control unit 90 (hereafter referred to as brake ECU 90). In response to a driving signal received from the brake ECU 90, the brake actuator 92 is actuated to generate a hydraulic pressure in the hydraulic circuit 93. The generated hydraulic pressure is transmitted to the disk brakes 91,91 to apply a braking force to the drive wheels 39,39. The brake ECU 90 sends the driving signal to the brake actuator 92 in response to output of a control signal from the hybrid electronic control unit 70 to the brake ECU 90, which is generally triggered by the driver's depression of the brake pedal 85 but may occur without the driver's depression of the brake pedal 85 under some operating conditions. The hybrid vehicle 20 adopts other braking applications, in addition to the hydraulic braking; regenerative braking application that converts the kinetic energy of the ring gear shaft 32a or the driveshaft into electrical energy by means of the motor MG2 and applies the electrical energy as a braking force to the ring gear shaft 32a or the driveshaft, and engine braking application that changes the rotation speed of the engine 22 with no fuel injection by means of the motor MG1 to utilize the internal resistance of the engine 22 as a braking force. The hybrid electronic control unit 70 sets a distribution ratio for allocation of a computed braking force demand to the hydraulic braking application, the regenerative braking application, and the engine braking application, and performs braking control to output the respective braking forces at the preset distribution ratio to the driveshaft.

The hybrid electronic control unit 70 is constructed as a microprocessor including a CPU 72, a ROM 74 that stores processing programs, a RAM 76 that temporarily stores data, input and output ports (not shown), and a communication port (not shown). The hybrid electronic control unit 70 receives, via its input port, an ignition signal from an ignition switch 80, a gearshift position SP or a current setting position of a gearshift lever 81 from a gearshift position sensor 82, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, and a vehicle speed V from a vehicle speed sensor 88. The positions of the gearshift lever 81 changeable as the gearshift position SP include a sequential gearshift position (S position), as well as conventional gearshift positions, that is, a drive position (D position) for forward driving, a reverse position (R position) for reverse driving, a brake position (B position) for efficient application of regenerative braking, a parking position (P position) for parking, and a neutral position (N position) for neutral gear. In the structure of this embodiment, the setting of the gearshift position SP to the S position allows 5-speed sequential gearshift from a lowest gear speed S1 to a highest gear speed S5. In response to the driver's operation of the gearshift lever 81, the hybrid electronic control unit 70 regulates the rotation speed of the engine 22 to exert an upshift or downshift effect. When the driver makes an upshift operation in the gearshift position SP set to the S position, the rotation speed of the engine 22 is lowered to give a pseudo-upshift effect of varying the change gear ratio in the upshift direction. When the driver makes a downshift operation in the gearshift position SP set to the S position, on the other hand, the rotation speed of the engine 22 is increased to give a pseudo-downshift effect of varying the change gear ratio in the downshift direction. The hybrid electronic control unit 70 is connected with the engine ECU 24, the motor ECU 40, the battery ECU 52, and the brake ECU 90 via the communication port to transmit diverse control signals and data to and from the engine ECU 24, the motor ECU 40, the battery ECU 52, and the brake ECU 90.

The hybrid vehicle 20 of the embodiment constructed as described above sets a torque demand to be output to the ring gear shaft 32a or the drive shaft, based on the vehicle speed V and the accelerator opening Acc (corresponding to the driver's depression amount of the accelerator pedal 83), and drives and controls the engine 22 and the motors MG1 and MG2 to ensure output of a power demand equivalent to the preset torque demand to the ring gear shaft 32a. There are several drive control modes of the engine 22 and the motors MG1 and MG2. In a torque conversion drive mode, while the engine 22 is driven and controlled to output a required level of power corresponding to the power demand, the motors MG1 and MG2 are driven and controlled to enable all the output power of the engine 22 to be subjected to torque conversion by the power distribution integration mechanism 30 and the motors MG1 and MG2 and to be output to the ring gear shaft 32a. In a charge-discharge drive mode, the engine 22 is driven and controlled to output a required level of power corresponding to the sum of the power demand and electric power used to charge the battery 50 or discharged from the battery 50. The motors MG1 and MG2 are driven and controlled to enable all or part of the output power of the engine 22, which is equivalent to the power demand with charge or discharge of the battery 50, to be subjected to torque conversion by the power distribution integration mechanism 30 and the motors MG1 and MG2 and to be output to the ring gear shaft 32a. In a motor drive mode, the motor MG2 is driven and controlled to ensure output of a required level of power corresponding to the power demand to the ring gear shaft 32a, while the engine 22 stops its operation. The hybrid vehicle 20 of the embodiment also calculates a braking torque demand to be output to the ring gear shaft 32a or the driveshaft, based on the vehicle speed V, the accelerator opening Acc (corresponding to the driver's depression amount of the accelerator pedal 83), and the brake pedal position BP (corresponding to the driver's depression amount of the brake pedal 85), and controls the motors MG1 and MG2 and the disk brakes 91,91 to ensure output of a braking force equivalent to the preset braking torque demand to the ring gear 32.

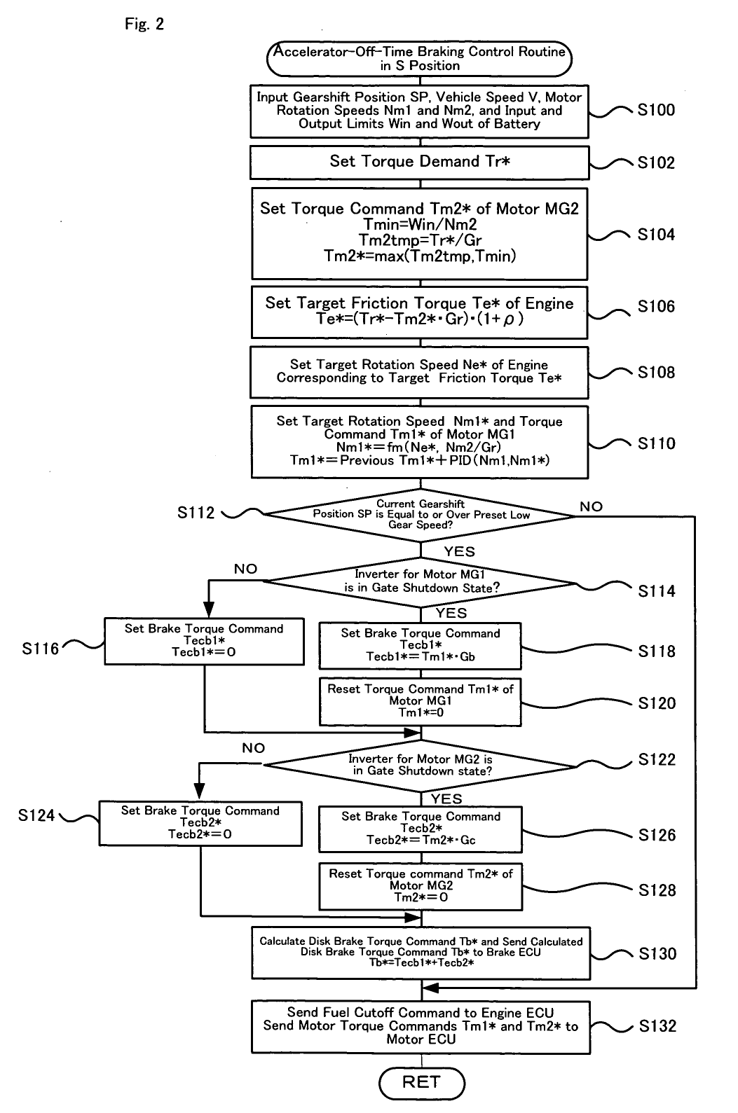

The description regards the operations of the hybrid vehicle 20 of the embodiment having the configuration discussed above, especially a series of control in response to the driver's release of the accelerator pedal 83 in a released state of the brake pedal 85 during a drive. FIG. 2 is a flowchart showing an accelerator-off-time braking control routine in the S position executed by the hybrid electronic control unit 70 in this embodiment. This braking control routine is repeatedly executed at preset time intervals, for example, at every 8 msec, in the setting of the S position to the gearshift position SP of the gearshift lever 81 detected by the gearshift position sensor 82 or in response to a gear change from the D position to the S position. The braking control of this routine utilizes regenerative braking by the motor MG2 or engine braking by the rotational resistance of the engine 22.

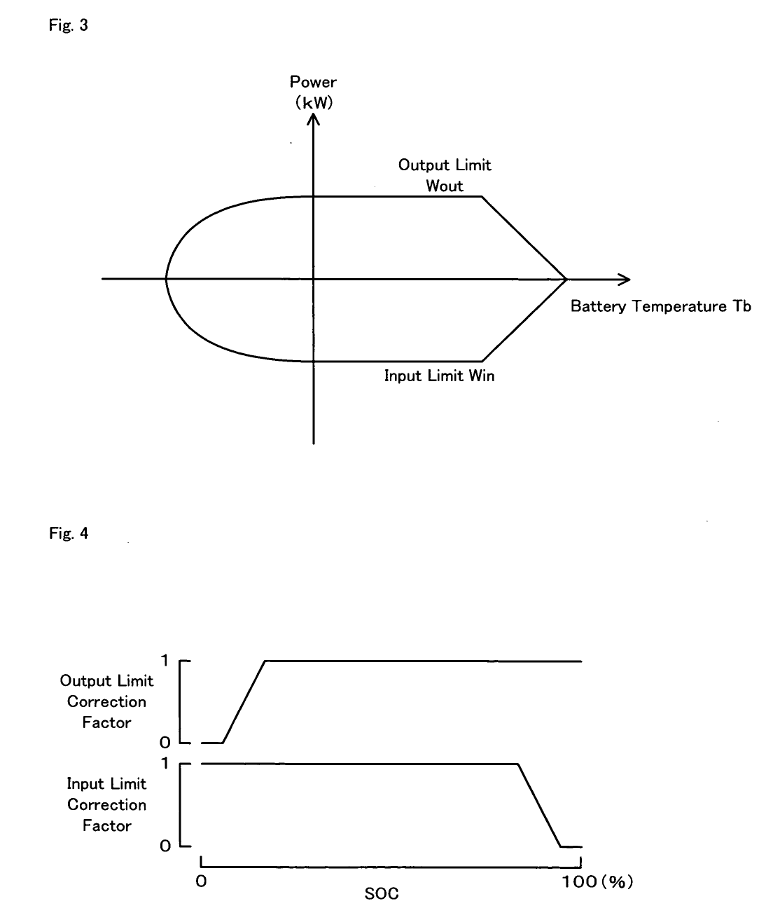

In the accelerator-off-time braking control routine in the S position, the CPU 72 of the hybrid electronic control unit 70 first inputs various data required for control, that is, the gearshift position SP from the gearshift position sensor 82, the vehicle speed V from the vehicle speed sensor 88, rotation speeds Nm1 and Nm2 of the motors MG1 and MG2, and an input limit Win and an output limit Wout of the battery 50 (step S100). The rotation speeds Nm1 and Nm2 of the motors MG1 and MG2 are computed from the rotational positions of the respective rotors in the motors MG1 and MG2 detected by the rotational position detection sensors 43 and 44 and are received from the motor ECU 40 by communication. The input limit Win and the output limit Wout of the battery 50 are set based on the battery temperature measured by the temperature sensor 51 and the state of charge SOC of the battery 50 and are received from the battery ECU 52 by communication. A concrete procedure sets base values of the input limit Win and the output limit Wout corresponding to the measured battery temperature, specifies an input limit correction factor and an output limit correction factor corresponding to the state of charge SOC of the battery 50, and multiplies the base values of the input limit Win and the output limit Wout by the specified input limit correction factor and output limit correction factor to determine the input limit Win and the output limit Wout of the battery 50. FIG. 3 shows variations of the input limit Win and the output limit Wout against the battery temperature Tb. FIG. 4 shows variations of the input limit correction factor and the output limit correction factor against the state of charge SOC of the battery 50.

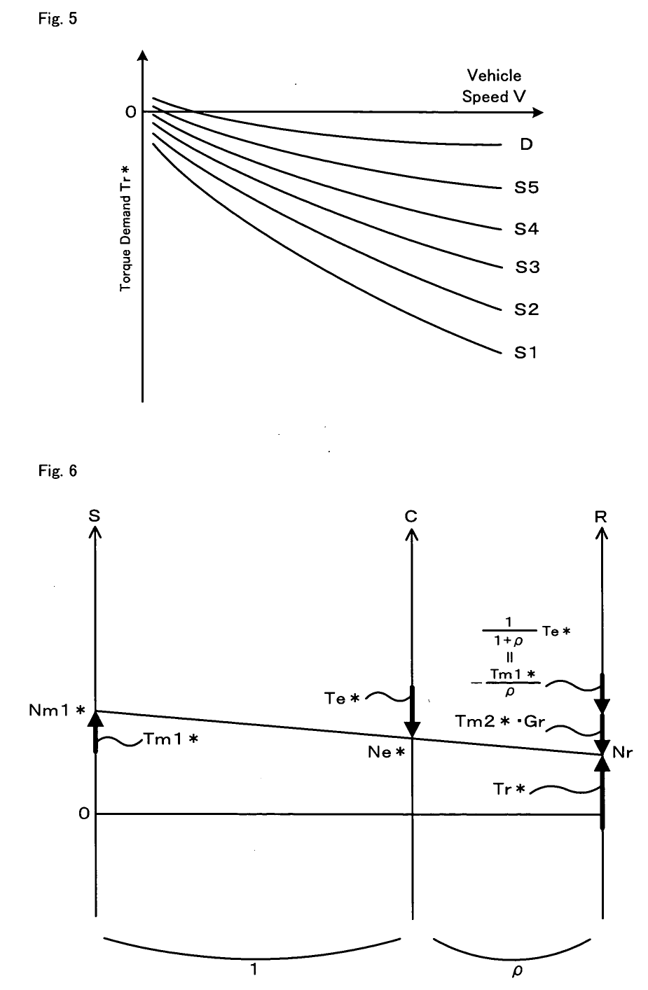

After the data input, the CPU 72 sets a torque demand Tr* to be output to the ring gear shaft 32a or the driveshaft, based on the input gearshift position SP and the input vehicle speed V (step S102). A concrete procedure of setting the torque demand Tr* in this embodiment stores in advance variations in torque demand Tr* against the gearshift position SP and the vehicle speed V as a torque demand setting map in the ROM 74 and reads the torque demand Tr* corresponding to the given gearshift position SP and the given vehicle speed V from the map. One example of the torque demand setting map is shown in FIG. 5. The torque demand Tr* has positive values in acceleration and negative values in deceleration. A curve ‘D’ in the map of FIG. 5 shows a variation in torque demand Tr* against the vehicle speed V in the gearshift position SP set to the D position. Curves ‘S1’ to ‘S5’ in the map show variations in torque demand Tr* against the vehicle speed V in the gearshift position SP set to the S position. The relation between the torque demand Tr* and the vehicle speed V in the S position is set to give the smaller torque demand Tr* at the lower gear speed, that is, to give the greater deceleration torque at the lower gear speed.

The CPU 72 then sets a torque command Tm2* of the motor MG2 (step S104). A concrete procedure divides the input limit Win of the battery 50 by the rotation speed Nm2 of the motor MG2 to compute a lower torque restriction Tmin of the motor MG2, divides the torque demand Tr* by a gear ratio Gr of the reduction gear 35 to compute a tentative motor torque Tm2tmp, and sets the greater between the computed lower torque restriction Tmin and the computed tentative motor torque Tm2tmp to the torque command Tm2* of the motor MG2. Such setting of the torque command Tm2* ensures output of a braking torque from the motor MG2 within the input limit Win of the battery 50.

After setting the torque command Tm2* of the motor MG2, the CPU 72 sets a target friction torque Te* of the engine 22 from the torque demand Tr*, the torque command Tm2* of the motor MG2, the gear ratio Gr of the reduction gear 35, and a gear ratio ρ of the power distribution integration mechanism 30 (=number of teeth of sun gear 31/number of teeth of ring gear 32) according to Equation-(1) given below (step S106):
Te*=(Tr*−Tm2*·Gr)·(1+ρ) (1)

FIG. 6 is an alignment chart showing torque-rotation speed dynamics of the respective rotation elements included in the power distribution integration mechanism 30. The left axis ‘S’, the middle axis ‘C’, and the right axis ‘R’ respectively show the rotation speed of the sun gear 31, the rotation speed of the carrier 34, and the rotation speed Nr of the ring gear 32 (ring gear shaft 32a). Two downward thick arrows on the axis ‘R’ in FIG. 6 respectively show a torque that is directly transmitted to the ring gear shaft 32a when the torque Te* is output from the engine 22 in steady operation at a specific drive point of the target rotation speed Ne* and the target torque Te*, and a torque that is applied to the ring gear shaft 32a via the reduction gear 35 when a torque Tm2* is output from the motor MG2.

A target rotation speed Ne* of the engine 22 is then set corresponding to the target friction torque Te* (step S108). A concrete procedure of setting the target rotation speed Ne* in this embodiment stores in advance a variation in target rotation speed Ne* against the target friction torque Te* as a rotation speed-torque map (not shown) in the ROM 74 and reads the target rotation speed Ne* corresponding to the given target friction torque Te* from the rotation speed-torque map.

The CPU 72 calculates a target rotation speed Nm1* of the motor MG1 from the target rotation speed Ne* of the engine 22, the rotation speed Nr (=Nm2/Gr) of the ring gear shaft 32a, and the gear ratio ρ of the power distribution integration mechanism 30 (=number of teeth of sun gear 31/number of teeth of ring gear 32) according to Equation (2) given below, while calculating a torque command Tm1* of the motor MG1 from the calculated target rotation speed Nm1* and the current rotation speed Nm1 of the motor MG1 according to Equation (3) given below (step S110):
Nm1*=(Ne*·(1+ρ)−Nm2/Gr)/ρ (2)
Tm1*=Previous Tm1*+KP(Nm1*−Nm1)+KI∫(Nm1*−Nm1)dt (3)

Equation (2) is a dynamic relational expression of the rotation elements included in the power distribution integration mechanism 30 and is readily introduced from the alignment chart of FIG. 6. Drive control of the motor MG1 with the settings of the torque command Tm1* and the target rotation speed Nm1* enables rotation of the engine 22 at the target rotation speed Ne*. Equation (3) is a relational expression of feedback control to drive and rotate the motor MG1 at the target rotation speed Nm1*. In Equation (3) given above, ‘KP’ in the second term and ‘KI’ in the third term on the right side respectively denote a gain of the proportional and a gain of the integral term.

After setting the target rotation speed Ne* of the engine 22 and the torque commands Tm1* and Tm2* of the motors MG1 and MG2, the CPU 72 specifies whether the current gearshift position SP is equal to or lower than a preset low gear speed (step S112). In this embodiment, the low gear speed is set to the second gear speed ‘S2’ among the five gear speeds ‘S1’ through ‘S5’. When the current gearshift position SP is equal to or above the third gear speed ‘S3’ (step S112: No), the CPU 72 sends a fuel cutoff command to the engine ECU 24 and transmits the torque commands Tm1* and Tm2* of the motors MG1 and MG2 to the motor ECU 40 (step S132). The CPU 72 then exits from this accelerator-off-time braking control routine in the S position. The engine ECU 24 receives the fuel cutoff command and controls the engine 22 to cut off the fuel supply. The motor ECU 40 receives the torque commands Tm1* and Tm2* and performs switching control of the switching elements included in the respective inverters 41 and 42 to drive the motor MG1 with the torque command Tm1* and the motor MG2 with the torque command Tm2*. When the output of the motor MG2 is sufficient for the required braking force equivalent to the torque demand Tr*, the hybrid vehicle 20 is decelerated by only regenerative braking of the motor MG2, with preference to charging the battery 50. When the output of the motor MG2 is insufficient for the required braking force equivalent to the torque demand Tr*, on the other hand, the hybrid vehicle 20 is decelerated by the friction torque of the engine 22 as well as by regenerative braking of the motor MG2. The friction torque of the engine 22 is generated by increasing the rotation speed Ne of the engine 22 under no combustion control by means of the motor MG1.

When the current gearshift position SP is equal to or below the second gear speed ‘S2’ (step S112: Yes), the CPU 72 sequentially identifies execution or non-execution of gate shutdown, which turns off all the switching elements, with regard to the inverter 41 for the motor MG1 (step S114) and execution or non-execution of the gate shutdown with regard to the inverter 42 for the motor MG2 (step S122). The gates are shut down in the inverter 41, for example, in the event of some failure of the inverter 41 and in response to some requirement for protecting the normal inverter 41, for example, in response to a temperature rise of the inverter 41 to or over a preset high temperature. The gates are shut down in the inverter 42 at similar timings. The motor ECU 40 gives control commands to the inverters 41 and 42 to attain the gate shutdown. In the structure of the embodiment, the CPU 72 identifies execution or non-execution of the gate shutdown with regard to the inverters 41 and 42, based on signals received from the motor ECU 40 by communication. In the case of non-execution of the gate shutdown with regard to either of the inverters 41 and 42 (step S114, S122: No), both the motors MG1 and MG2 can normally output torques equivalent to the torque commands Tm1* and Tm2*. The CPU 72 accordingly sets a value ‘0’ to both a brake torque command Tecb1* to be applied by the disk brakes 91,91 as a complement for the braking torque Tm1* of the motor MG1 (step S116) and a brake torque command Tecb2* to be applied by the disk brakes 91, 91 as a complement for the braking torque Tm2* of the motor MG2 (step S124). A disk brake torque command Tb* to be applied by the disk brakes 91,91 is then calculated as a sum of the brake torque command Tecb1* and the brake torque command Tecb2* (step S130). When the gates are not shut down in either the inverter 41 for the motor MG1 or in the inverter 42 for the motor MG2, the brake torque command Tecb1* and the brake torque command Tecb2* are both equal to 0. The disk brake torque command Tb* is accordingly equal to 0. The CPU 72 then sends the calculated disk brake torque command Tb* (=0) to the brake ECU 90 (step S130), and sends the fuel cutoff command to the engine ECU 24 and transmits the torque commands Tm1* and Tm2* of the motors MG1 and MG2 to the motor ECU 40 (step S132). The CPU 72 then exits from this accelerator-off-time braking control routine in the S position.

The braking control routine has the different processing flow in the case of execution of the gate shutdown with regard to at least either the inverter 41 for the motor MG1 or the inverter 42 for the motor MG2. The gate shutdown of the inverter 41 for the motor MG1 turns off all the switching elements included in the inverter 41 to shut down the gates of the inverter 41 and prevent any input and output of electric power to and from the motor MG1. The motor MG1 can thus not output a torque equivalent to the torque command Tm1*. Under this condition, the disk brakes 91,91 are used to apply a required braking force corresponding to the torque command Tm1*, which is to be output from the motor MG1. The CPU 72 accordingly calculates the brake torque command Tecb1* in the disk brake torque command Tb* of the disk brakes 91,91 by multiplying the torque command Tm1* of the motor MG1 by a conversion factor Gb (step S118) and resets the torque command Tm1* of the motor MG1 to 0 (step S120). The setting of the brake torque command Tecb1* ensures application of the required braking force to be output from the motor MG1. The conversion factor Gb is set to convert the torque command Tm1* into a torque output to the drive wheels 39,39 as a braking torque to be output to the ring gear shaft 32a. When the gates are shut down in the inverter 42 for the motor MG2, the disk brakes 91,91 are used to apply a required braking force corresponding to the torque command Tm2*, which is to be output from the motor MG2. The CPU 72 accordingly calculates the brake torque command Tecb2* in the disk brake torque command Tb* of the disk brakes 91, 91 by multiplying the torque command Tm2* of the motor MG2 by a conversion factor Gc (step S126) and resets the torque command Tm2* of the motor MG2 to 0 (step S128). The setting of the brake torque command Tecb2* ensures application of the required braking force to be output from the motor MG2. The conversion factor Gc is set to convert the torque command Tm2* into a torque output to the drive wheels 39,39 as a braking torque to be output to the ring gear shaft 32a.

The CPU 72 sums up the brake torque command Tecb1* and the brake torque command Tecb2* to calculate the disk brake torque command Tb*, which is to be applied by the disk brakes 91,91, and sends the calculated disk brake torque command Tb* to the brake ECU 90 (step S130). In the case of execution of the gate shutdown with regard to only the inverter 41 for the motor MG1, the affirmative answer is given at step S114 and the negative answer is given at step S122. The disk brake torque command Tb* of the disk brakes 91, 91 calculated at step S130 is thus equal to the brake torque command Tecb1* (=Tm1*·Gb) to supply the required braking force of the motor MG1. In the case of execution of the gate shutdown with regard to only the inverter 42 for the motor MG2, the negative answer is given at step S114 and the affirmative answer is given at step S122. The disk brake torque command Tb* of the disk brakes 91,91 calculated at step S130 is thus equal to the brake torque command Tecb2* (=Tm2*·Gc) to supply the required braking force of the motor MG2. In the case of execution of the gate shutdown with regard to both the inverter 41 for the motor MG1 and the inverter 42 for the motor MG2, the affirmative answer is given at both steps S114 and S122. The disk brake torque command Tb* of the disk brakes 91,91 calculated at step S130 is thus equal to the sum of the brake torque command Tecb1* (=Tm1*·Gb) to supply the required braking force of the motor MG1 and the brake torque command Tecb2* (=Tm2*·Gc) to supply the required braking force of the motor MG2.

In the case of execution of the gate shutdown with regard to at least either the inverter 41 for the motor MG1 or the inverter 42 for the motor MG2, the CPU 72 calculates the disk brake torque command Tb* of the disk brakes 91,91 and sends the calculated disk brake torque command Tb* to the brake ECU 90 (step S130). The CPU 72 then sends the fuel cutoff command to the engine ECU 24 and transmits the torque commands Tm1* and Tm2* of the motors MG1 and MG2 to the motor ECU 40 (step S132), before exiting from this accelerator-off-time braking control routine in the S position. The engine ECU 24 receives the fuel cutoff command and controls the engine 22 to cut off the fuel supply. The motor ECU 40 receives the torque commands Tm1* and Tm2* and performs switching control of the switching elements included in the respective inverters 41 and 42 to drive the motor MG1 with the torque command Tm1* and the motor MG2 with the torque command Tm2*. The brake ECU 90 receives the disk brake torque command Tb* and controls the brake actuator 92 to ensure output of a brake force equivalent to the disk brake torque command Tb* from the disk brakes 91,91. The brake actuator 92 generates a hydraulic pressure in the hydraulic circuit 93 and transmits the generated hydraulic pressure to the disk brakes 91,91. The disk brakes 91,91 accordingly apply a braking force equivalent to the disk brake torque command Tb* to the drive wheels 39,39. Even in the gate shutdown state of the inverter 41 for the motor MG1 where all the switching elements in the inverter 41 are off or in the gate shutdown state of the inverter 42 for the motor MG2 where all the switching elements in the inverter 42 are off, the disk brakes 91,91 output the required braking force to compensate for the lack of braking force output from the motor MG1 or for the lack of braking force output from the motor MG2. The braking control of this embodiment thus effectively prevents an unintentional decrease in braking force applied to the hybrid vehicle 20.

The hybrid electronic control unit 70 of the embodiment is equivalent to the braking control module of the invention. The hydraulic circuit 93 and the disk brakes 91,91 of the embodiment correspond to the braking force output mechanism of the invention. The gearshift lever 81 and the hybrid electronic control unit 70 of the embodiment correspond to the gear speed change unit of the invention. The engine 22, the motor MG1 and the power distribution integration mechanism 30, and the motor MG2 of the embodiment are respectively equivalent to the internal combustion engine, the electric power-mechanical power input output mechanism, and the motor of the invention. The battery 50, the inverter 41, and the inverter 42 of the embodiment respectively correspond to the accumulator unit, the first driving circuit, and the second driving circuit of the invention. The description of the embodiment about the operations of the hybrid vehicle 20 explicitly explains not only the hybrid vehicle of the invention but the control method of the hybrid vehicle.

In the gate shutdown state of the inverter 41 for the motor MG1, the motor MG1 can not output a required braking force corresponding to the torque command Tm1* to the ring gear shaft 32a by taking into account the friction torque of the engine 22. In the gate shutdown state of the inverter 42 for the motor MG2, the motor MG2 can not output a required regenerative braking force corresponding to the torque command Tm2* to the ring gear shaft 32a. In such cases, the hybrid vehicle 20 of the embodiment controls the disk brakes 91,91 to compensate for the insufficiency of braking force. This arrangement desirably prevents an unintentional decrease in braking force applied to the hybrid vehicle 20.

The braking control of this embodiment controls the actuator 93, which is operable independently of the motors MG1 and MG2, to ensure output of the braking force from the disk brakes 91,91 and automatically compensate for all the insufficiency of braking force. This arrangement effectively covers the insufficiency of required braking force. The braking control of the embodiment utilizes part of the existing hydraulic braking system conventionally mounted on the automobile and accordingly does not require any additional braking system to compensate for the insufficiency of braking force.

The greater braking force is output from the motor MG1 or from the motor MG2 at the lower gear speed, compared with the output braking force at the higher gear speed. The technique of the invention is thus especially effective at the setting of the low gear speed to compensate for the insufficiency of braking force and to prevent the driver from feeling an idle drive.

Regenerative braking and engine braking are often used in the accelerator released state, so that the technique of the invention is especially effective in the accelerator released state.

The embodiment discussed above is to be considered in all aspects as illustrative and not restrictive. There may be many modifications, changes, and alterations without departing from the scope or spirit of the main characteristics of the present invention. Some examples of possible modification are given below.

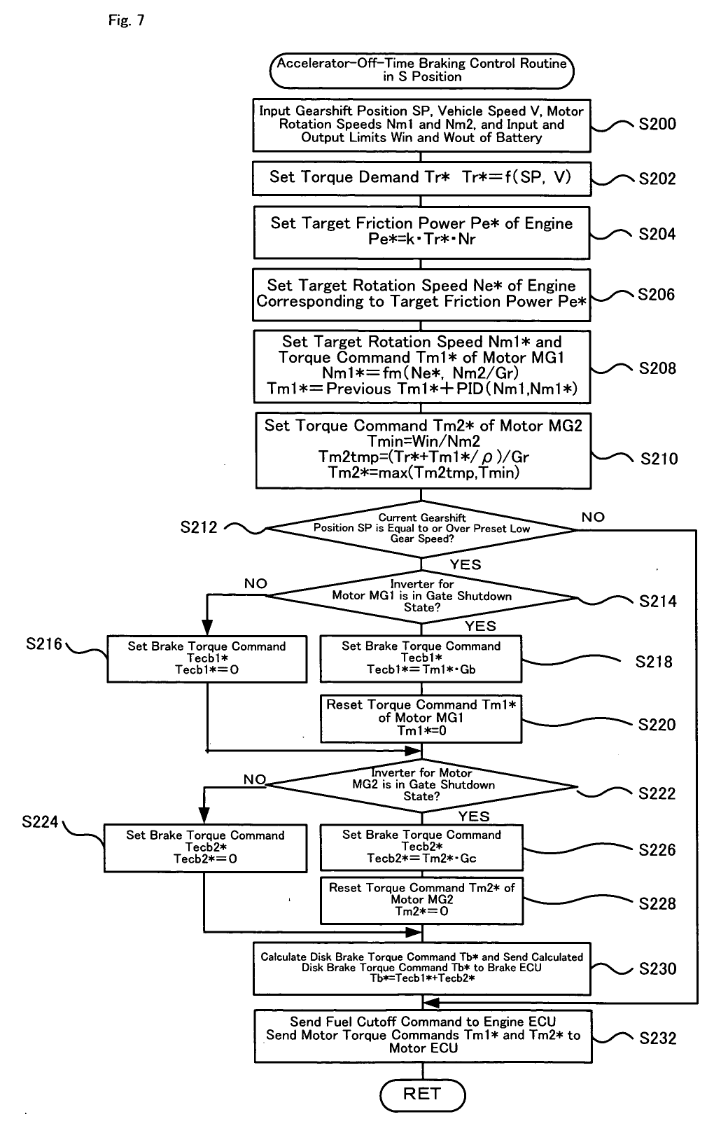

For example, a modified accelerator-off-time braking control routine in the S position shown in the flowchart of FIG. 7 may be executed instead of the accelerator-off-time braking control routine in the S position shown in the flowchart of FIG. 2. The modified accelerator-off-time braking control routine of FIG. 7 has steps S204 to S210, in place of steps S104 to S110. In this modified braking control routine, the CPU 72 multiplies the product of the torque demand Tr* and the rotation speed Nr of the ring gear shaft 32a by a preset coefficient k, for example, 0.5 to set a target friction power Pe* of the engine 22 (step S204). The CPU 72 subsequently sets the target rotation speed Ne* of the engine 22 corresponding to the target friction power Pe* (step S206) and sets the target rotation speed Nm1* and the torque command Tm1* of the motor MG1 to drive the engine 22 at the target rotation speed Ne* (step S208). The CPU 72 then sets the torque command Tm2* of the motor MG2 to ensure output of a remaining torque demand from the motor MG2 within the input limit Win of the battery 50 (step S210). The subsequent processing of steps S212 to S232 in the modified accelerator-off-time braking control routine of FIG. 7 is identical with the processing of steps S112 to S132 in the accelerator-off-time braking control routine of FIG. 2 and is thus not specifically described here.

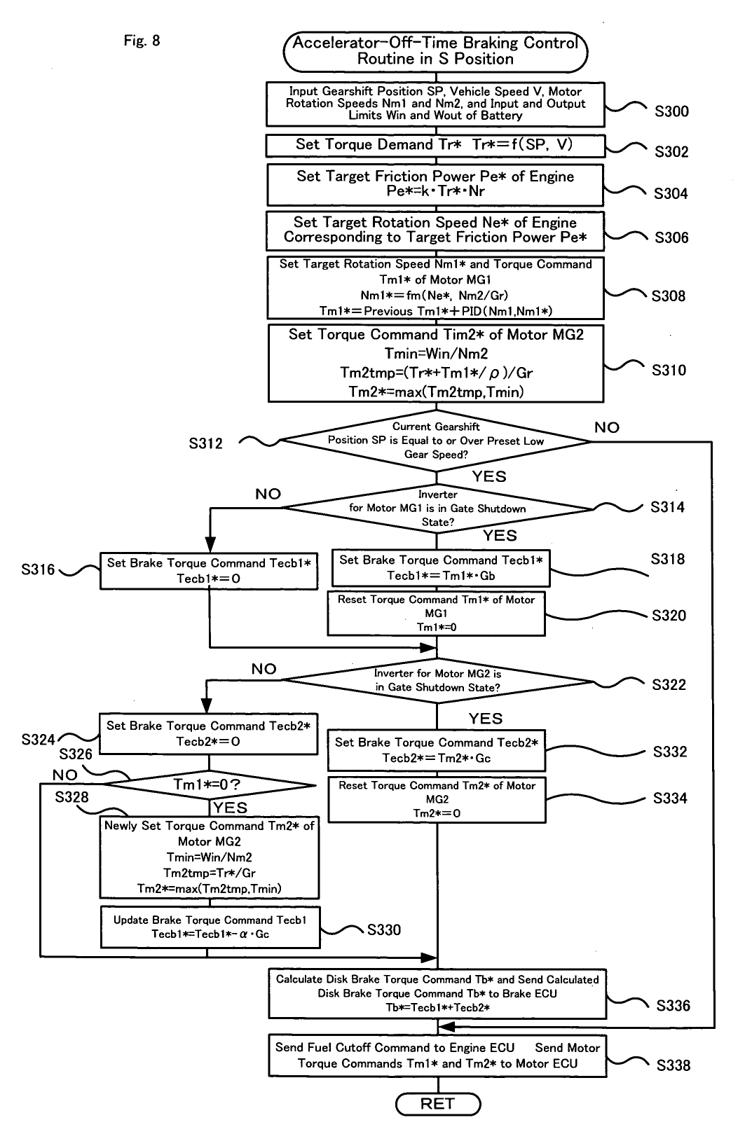

The accelerator-off-time braking control routine of FIG. 7 may further be modified to give preference to application of the regenerative braking of the motor MG2 over application of the braking force by the disk brakes 91,91 to compensate for the insufficiency of braking force in the case of execution of the gate shutdown with regard to only the inverter 41 for the motor MG1. A further modified flow of the accelerator-off-time braking control is given in the flowchart of FIG. 8. After the processing of steps S300 to S320 that is identical with the processing of steps S200 to S220 in the accelerator-off-time braking control routine of FIG. 7, the modified accelerator-off-time braking control routine of FIG. 8 identifies execution or non-execution of the gate shutdown with regard to the inverter 42 for the motor MG2 at step S322 and executes the processing flow of steps S324 to S334, instead of steps S224 to S228. In the case of non-execution of the gate shutdown with regard to the inverter 42 for the motor MG2 (step S322: No), the CPU 72 sets a value ‘0’ to the brake torque command Tecb2* to be applied by the disk brakes 91,91 as a complement for the braking torque Tm2* of the motor MG2 (step S324). The CPU 72 then specifies whether the torque command Tm1* of the motor MG1 is equal to 0 (step S326). In the gate shutdown state of the inverter 41 for the motor MG1 where all the switching elements in the inverter 41 are off, the affirmative answer is given at step S326. The CPU 72 divides the input limit Win of the battery 50 by the rotation speed Nm2 of the motor MG2 to recalculate the lower torque restriction Tmin of the motor MG2, divides the torque demand Tr* by the gear ratio Gr of the reduction gear 35 to recalculate the tentative motor torque Tm2tmp, and newly sets the greater between the recalculated lower torque restriction Tmin and the recalculated tentative motor torque Tm2tmp to the torque command Tm2* of the motor MG2 (step S328). The CPU 72 then updates the brake torque command Tecb1* (step S330). The brake torque command Tecb1* is updated by subtracting the product α·Gc of a difference a between the torque command Tm2* newly set at step S328 and the torque command Tm2* previously set at step S310 and a conversion factor Gc from the previous setting of the torque command Tecb1*. Here the product α·Gc represents a regenerative braking torque of the motor MG2 to compensate for the insufficiency of braking torque caused by the gate shutdown of the inverter 41. The accelerator-off-time braking control routine of FIG. 8 executes the processing of steps S336 and S338, which is identical with the processing of steps S230 and S232 in the accelerator-off-time braking control routine of FIG. 7. In the case of execution of the gate shutdown with regard to the inverter 42 for the motor MG2 (step S322: Yes), the accelerator-off-time braking control routine of FIG. 8 executes the processing of steps S332 and S334, which is identical with the processing of steps S226 and S228 in the accelerator-off-time braking control routine of FIG. 7. This modified braking control shown in the flowchart of FIG. 8 gives preference to application of regenerative braking of the motor MG2 over application of the braking force by the disk brakes 91,91 to compensate for the insufficiency of braking force in the gate shutdown state of only the inverter 41 for the motor MG1, when the tentative motor torque Tm2tmp of the motor MG2 is greater than the lower torque restriction Tmin at step S310. In this case, the regenerative braking of the motor MG2 with the torque command Tm2* set at step S310 causes the state of charge SOC of the battery 50 to be lower than the input limit Win. The preference given to application of the regenerative braking of the motor MG2 in such cases desirably enhances the total energy efficiency of the hybrid vehicle 20.

The braking control of the embodiment is executed to apply the required braking force when the motor MG1 totally fails to output a braking force equivalent to the torque command Tm1* to the ring gear shaft 32a by utilizing the friction torque of the engine 22 or when the motor MG2 totally fails to output a regenerative braking force equivalent to the torque command Tm2* to the ring gear shaft 32a. The technique of the invention is also applicable to compensate for the insufficiency of braking force when the motor MG1 outputs a braking force that satisfies only part of the torque command Tm1* to the ring gear shaft 32a by utilizing the friction torque of the engine 22 or when the motor MG2 outputs a regenerative braking force that satisfies only part of the torque command Tm2* to the ring gear shaft 32a. Such insufficiency of braking torque occurs, for example, when the output of the motor MG1 or the output of the motor MG2 is restricted by the gate shutdown of the inverter 41 for the motor MG1 or by the gate shutdown of the inverter 42 for the motor MG2.

The above embodiment and its modified examples regard the braking control in the released state of both the accelerator pedal 83 and the brake pedal 85. The technique of the invention is also applicable to braking control with depression of the brake pedal 85 in the released state of the accelerator pedal 83 or to braking control with a decreased amount of depression of the accelerator pedal 83.

The hybrid vehicle 20 of the embodiment uses the disk brakes 91,91 to compensate for the insufficiency of braking force. The disk brakes 91,91 are, however, not restrictive and may be replaced by any means to output a braking force to the ring gear shaft 32a or the driveshaft, irrespective of the driver's operation.

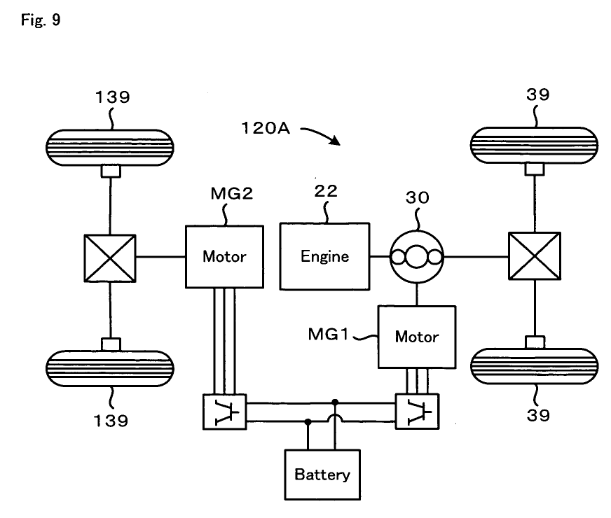

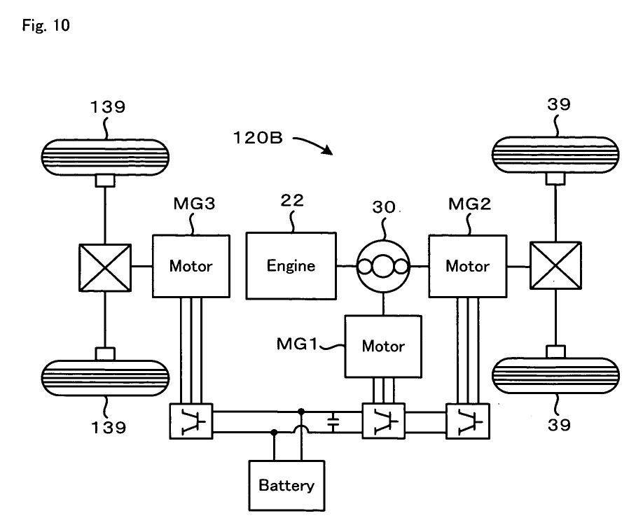

In the hybrid vehicle 20 of the embodiment, the power of the motor MG2 is subjected to gear change by the reduction gear 35 and is output to the ring gear shaft 32a. In one possible modification shown as a hybrid vehicle in FIG. 9, the power of the motor MG2 may be output to another axle (that is, an axle linked with wheels 139), which is different from an axle connected with the ring gear shaft 32a (that is, an axle linked with the wheels 39).

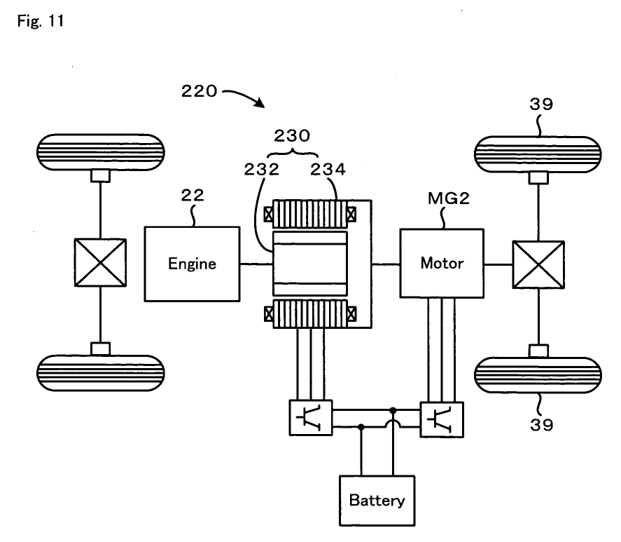

In the hybrid vehicle 20 of the embodiment, the power of the engine 22 is output via the power distribution integration mechanism 30 to the ring gear shaft 32a functioning as the drive shaft linked with the drive wheels 39. In another possible modification of FIG. 11, a hybrid vehicle 320 may have a pair-rotor motor 230, which has an inner rotor 232 connected with the crankshaft 26 of the engine 22 and an outer rotor 234 connected with the drive shaft for outputting the power to the drive wheels 39 and transmits part of the power output from the engine 22 to the drive shaft while converting the residual part of the power into electric power.

The present application claims the benefit of priority from Japanese Patent Application No. 2005-183085 filed on Jun. 23, 2005, the entire contents of which is incorporated by reference herein.

What is claimed is:

1. A hybrid vehicle that outputs power to a driveshaft, said hybrid vehicle comprising:
an internal combustion engine that has an output shaft and outputs power;
an electric power-mechanical power input output mechanism that is connected with the output shaft of the internal combustion engine and with the driveshaft and outputs at least part of the power of the internal combustion engine to the driveshaft with input and output of electric power while outputting a resistant braking force by a rotational resistance arising in the internal combustion engine to the driveshaft with input of electric power;
a motor that converts power of the driveshaft to electric power to output a regenerative braking force to the driveshaft;
a braking force output unit that outputs a braking force to the driveshaft; and
a braking control module that sets a resistant braking force demand to be output from the electric power-mechanical power input output mechanism to the driveshaft and a regenerative braking force demand to be output from the motor to the driveshaft and controls the electric power-mechanical power input output mechanism and the motor to ensure output of the resistant braking force demand and the regenerative braking force demand to the driveshaft,
when the electric power-mechanical power input output mechanism totally fails to output the resistant braking force demand or outputs only part of the resistant braking force demand or when the motor totally fails to output the regenerative braking force demand or outputs only part of the regenerative braking force demand, said braking control module executing braking force supplement control, which controls the electric power-mechanical power input output mechanism, the motor, and the braking force output unit to ensure supplementary output of an insufficient braking force from at least one of the electric power-mechanical power input output mechanism, the motor, and the braking force output unit.

2. A hybrid vehicle in accordance with claim 1, said hybrid vehicle further comprising:
an accumulator unit that inputs and outputs electric power from and to the electric power-mechanical power input output mechanism and the motor,
wherein said braking control module sets the regenerative braking force demand to restrict the input and output of the electric power to and from the accumulator unit within a preset restriction range.

3. A hybrid vehicle in accordance with claim 2, said hybrid vehicle further comprising:
a first driving circuit that is arranged between the electric power-mechanical power input output mechanism and the accumulator unit and has multiple switching elements, which are switched on and off to drive the electric power-mechanical power input output mechanism; and
a second driving circuit that is arranged between the motor and the accumulator unit and has multiple switching elements, which are switched on and off to drive the motor,
wherein said braking control module executes the braking force supplement control when the multiple switching elements in the first driving circuit are all switched off or when the multiple switching elements in the second driving circuit are all switched off.

4. A hybrid vehicle in accordance with claim 2, wherein the accumulator unit is charged with electric power converted from the power of the driveshaft, while the motor outputs a braking force to the driveshaft, and
when the electric power-mechanical power input output mechanism totally fails to output the resistant braking force demand or outputs only part of the resistant braking force demand, said braking control module specifies a distribution ratio of an insufficient braking force to the motor and the braking force output unit based on a state of charge of the accumulator unit and controls the motor and the braking force output unit to output supplementary braking forces according to the specified distribution ratio and compensate for the insufficient braking force.

5. A hybrid vehicle in accordance with claim 3, wherein the accumulator unit is charged with electric power converted from the power of the driveshaft, while the motor outputs a braking force to the driveshaft, and
when the electric power-mechanical power input output mechanism totally fails to output the resistant braking force demand or outputs only part of the resistant braking force demand, said braking control module specifies a distribution ratio of an insufficient braking force to the motor and the braking force output unit based on a state of charge of the accumulator unit and controls the motor and the braking force output unit to output supplementary braking forces according to the specified distribution ratio and compensate for the insufficient braking force.

6. A hybrid vehicle in accordance with claim 1, wherein when the electric power-mechanical power input output mechanism totally fails to output the resistant braking force demand or outputs only part of the resistant braking force demand or when the motor totally fails to output the regenerative braking force demand or outputs only part of the regenerative braking force demand, said braking control module controls the braking force output unit to output a supplementary braking force and compensate for an insufficiency of braking force.

7. A hybrid vehicle in accordance with claim 1, wherein the braking force output unit comprises a brake that outputs a hydraulic pressure-based braking force to the driveshaft by actuation of an actuator.

8. A hybrid vehicle in accordance with claim 1, said hybrid vehicle further comprising;
a gear speed change unit that has multiple different gear speeds selectable by a driver and gives a quasi-upshift effect or a quasi-downshift effect based on selection of a gear speed,
wherein said braking control module sets the resistant braking force demand and the regenerative braking force demand to increase output of a braking force to the driveshaft in response to the driver's selection of a lower gear speed among the multiple different gear speeds of the gear speed change unit,
said braking control module executes the braking force supplement control when the electric power-mechanical power input output mechanism totally fails to output the resistant braking force demand or outputs only part of the resistant braking force demand or when the motor totally fails to output the regenerative braking force demand or outputs only part of the regenerative braking force demand, and when the driver's selection of a gear speed is not higher than a preset low gear speed among the multiple different gear speeds of the gear speed change unit.

9. A hybrid vehicle in accordance with claim 1, wherein said braking control module executes the braking force supplement control when the electric power-mechanical power input output mechanism totally fails to output the resistant braking force demand or outputs only part of the resistant braking force demand or when the motor totally fails to output the regenerative braking force demand or outputs only part of the regenerative braking force demand, and when a driver's depression amount of an accelerator pedal is decreased or is set practically equal to zero.

10. A hybrid vehicle in accordance with claim 1, wherein said electric power-mechanical power input output mechanism includes:
a three shaft-type power input output module that is linked to three shafts, that is, an output shaft of the internal combustion engine, the drive shaft, and a third shaft, and determines power input from and output to a residual one shaft based on powers input from and output to any two shafts among the three shafts; and
a generator that inputs and outputs power from and to the third shaft.

11. A hybrid vehicle in accordance with claim 1, wherein said electric power-mechanical power input output mechanism includes:
a pair-rotor motor that has a first rotor linked to an output shaft of the internal combustion engine and a second rotor linked to the drive shaft, said pair-rotor motor outputting at least part of the power from said internal combustion engine to said drive shaft through input and output of electric power by electromagnetic interaction between the first rotor and the second rotor.

12. A control method of a hybrid vehicle that includes:
an internal combustion engine that has an output shaft and outputs power; an electric power-mechanical power input output mechanism that is connected with the output shaft of the internal combustion engine and with a driveshaft and outputs at least part of the power of the internal combustion engine to the driveshaft with input and output of electric power while outputting a resistant braking force by a rotational resistance arising in the internal combustion engine to the driveshaft with input of electric power; a motor that converts power of the driveshaft to electric power to output a regenerative braking force to the driveshaft; and a braking force output unit that outputs a braking force to the driveshaft, said control method comprising the steps of:
setting a resistant braking force demand to be output from the electric power-mechanical power input output mechanism to the driveshaft and a regenerative braking force demand to be output from the motor to the driveshaft and controlling the electric power-mechanical power input output mechanism and the motor to ensure output of the resistant braking force demand and the regenerative braking force demand to the driveshaft, and
when the electric power-mechanical power input output mechanism totally fails to output the resistant braking force demand or outputs only part of the resistant braking force demand or when the motor totally fails to output the regenerative braking force demand or outputs only part of the regenerative braking force demand, executing braking force supplement control, which controls the electric power-mechanical power input output mechanism, the motor, and the braking force output unit to ensure supplementary output of an insufficient braking force from at least one of the electric power-mechanical power input output mechanism, the motor, and the braking force output unit.
